(19) United States
(12) Patent Application Publication
(10) Pub. No.: US 2014/0374422 A1
(43) Pub. Date: Dec. 25, 2014

(54) WASTE RECEPTACLE VENTILATION SYSTEM AND METHOD

(71) Applicant: The Little Artist, Inc., Omaha, NE (US)

(72) Inventor: Tim Kasun, Omaha, NE (US)

(21) Appl. No.: 14/305,111

(22) Filed: Jun. 16, 2014

Related U.S. Application Data
(60) Provisional application No. 61/838,538, filed on Jun. 24, 2013.

(51) Int. Cl. B65F 1/06; B65F 1/14

(52) U.S. Cl. CPC B65F 1/06; B65F 1/14; B65F 2210/181
USPC 220/495.04

(57) ABSTRACT

A ventilation system for use with a waste receptacle and a trash bag disposed within the waste receptacle, defining an airspace between the trash bag and an inner surface of a waste receptacle wall. In one embodiment a U-shaped ventilation clip is positioned over a peripheral edge portion of the waste receptacle. A fluid channel extends through the ventilation clip between an interior opening, which is in open fluid communication with the airspace, and an outer opening, which is in open fluid communication with an airspace exterior to the waste receptacle.

### CROSS-REFERENCE TO RELATED APPLICATIONS

The present application is a non-provisional of U.S. Provisional Patent Application Ser. No. 61/838,538, titled “TRASH CAN DEVICE”, filed Jun. 24, 2013, which is incorporated herein as if set out in full.

### BACKGROUND

Waste containers include different forms of receptacles that are used to temporarily store and accumulate various types of waste. Over time the waste may decompose within the waste receptacles and produce a noxious odor within the receptacle. The decomposition process may also generate heat. Where the waste receptacle has a lid that covers the opening to the waste receptacle, the odor and heat become trapped within the waste receptacle. Over time, unreleased odor and heat accumulate in the waste receptacle. The accumulated odor and heat are released from within the waste receptacle when someone opens the waste receptacle lid or removes the lid from the base of the waste receptacle. The rush of warm, noxious odor is offensive to the individual who is simply adding more waste to the waste receptacle or emptying a full waste receptacle.

It is contemplated that one could simply leave the lid off of the waste receptacle while it accumulates waste over time. This would prevent the odor and heat from accumulating within the waste receptacle, only to be released as a large, noxious cloud when the lid is opened or removed. However, the lid serves the purpose of covering the unsightly appearance of the trash within the waste receptacle. One could also add a deodorizing device to the underside of the lid or elsewhere within the waste receptacle. Unfortunately, few deodorizing devices are successful in controlling the odor of waste. Many such systems simply add their own noxious cloud of perfume, making the odor released from an opened waste receptacle a sweet stench.

Even if one were to remove the lid or add a deodorizing device, such efforts would not address issues raised by waste receptacles that use a trash bag or liner. Waste receptacles that use trash bags or liners have an airspace trapped between the interior walls of the waste receptacle and the exterior of the trash bag or liner. This airspace becomes another critical area that traps the odors and heat emitted from the waste within the waste receptacle. Current efforts to reduce odor and heat generated by waste do not address the airspace between the interior walls of the waste receptacle and the exterior of the trash bag or liner. Nor do such efforts prevent the accumulation of odor or heat in this airspace until the trash bag or liner is removed from the waste receptacle. This is the point, just as the trash bag or liner is removed, that the individual gets hit with a second cloud of warm waste odor.

It is desirable to provide a waste receptacle ventilation system and method to provide a continuous exchange of air between the airspace between the interior walls of the waste receptacle and the exterior of the trash bag or liner and the environment surrounding the waste receptacle. Such a system and method would limit the buildup of odors and heat that may be generated by the decomposition of the waste.

### SUMMARY

This Summary is provided to introduce a selection of concepts in a simplified form that are further described below in the Detailed Description. This Summary, and the foregoing Background, is not intended to identify key aspects or essential aspects of the claimed subject matter. Moreover, this Summary is not intended for use as an aid in determining the scope of the claimed subject matter.

The present disclosure provides a waste receptacle ventilation system and method to provide a continuous exchange of air between an airspace, between an interior surface of a waste receptacle and an exterior of a trash bag or liner, and the environment surrounding the waste receptacle. In various embodiments, the waste receptacle ventilation system includes one or more ventilation clips. Embodiments of the ventilation clips are provided with an inverted U-shape, having an exterior arm and an opposing interior arm. Proximal end portions of the exterior arm and an opposing interior arm are coupled with a base portion.

In some embodiments, the ventilation clips may be extendable and retractable at their base portions in order to accommodate different widths and shapes of waste receptacle walls and peripheral edge portions. In at least one embodiment, the ventilation clip includes a male section and a female section that couple with one another at a telescoping joint by which the male section may extend and retract with respect to the female section.

Embodiments of the ventilation clips provide the female top portion with an inner fluid channel that extends from an opening in the shoulder portion, along a long axis through the female top portion. In such embodiments, the male top portion includes an outer fluid channel that extends from an opening in the bottom portion of a conforming lip section, along a long axis through vertical portion, and the male top portion. In various embodiments, the opening of the inner fluid channel is in open fluid communication with an interior cavity between the interior arm and the interior surface of the waste receptacle wall. Similarly, the opening of the outer fluid channel is in open fluid communication with the outer cavity between the exterior arm and the exterior surface of the waste receptacle wall. Embodiments of the present technology provide that the outer cavity do not have sidewalls that extend between the exterior arm toward the exterior surface of the waste receptacle wall. Similarly, in such embodiments, the interior cavity may not have sidewalls that extend between the interior arm toward the interior surface of the waste receptacle wall. In this manner, the airspace, between the interior surface of the waste receptacle and an exterior of the trash bag, is placed in open fluid communication with open to the environment surrounding the trash receptacle ventilation system and the exterior of the waste receptacle.

These and other aspects of the present system and method will be apparent after consideration of the Detailed Description and Figures herein. It is to be understood, however, that the scope of the invention shall be determined by the claims as issued and not by whether given subject matter addresses any or all issues noted in the Background or includes any features or aspects recited in this Summary.

### DRAWINGS

Non-limiting and non-exhaustive embodiments of the present invention, including the preferred embodiment, are described with reference to the following figures, wherein like reference numerals refer to like parts throughout the various views unless otherwise specified.

FIG. 1 illustrates a cross-sectional, side elevation view of one embodiment of a waste container and a waste container aeration device of the present technology.

FIG. 2 illustrates a front perspective view of a portion of the waste container and the waste container aeration device depicted in FIG. 1.

FIG. 3 illustrates a rear perspective view of a portion of the waste container and the waste container aeration device depicted in FIG. 1.

### DETAILED DESCRIPTION

Embodiments are described more fully below with reference to the accompanying figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense.

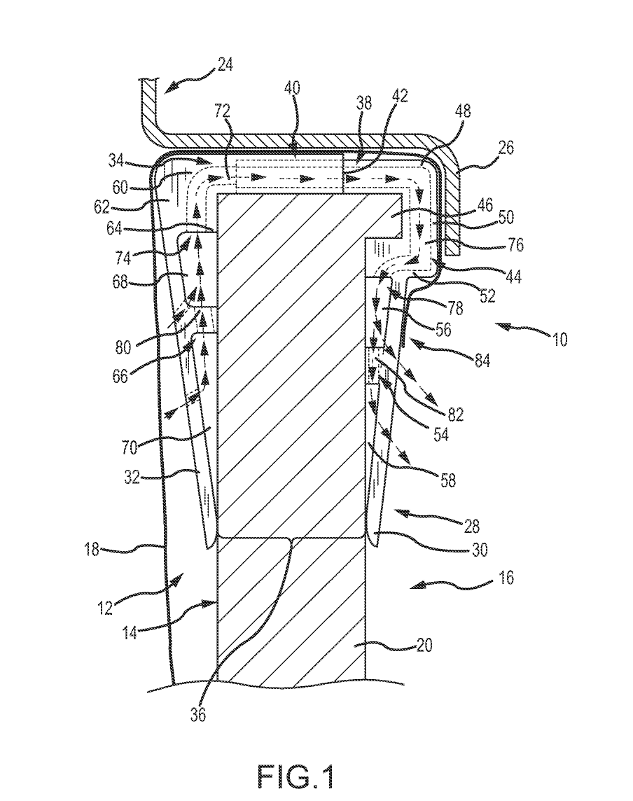

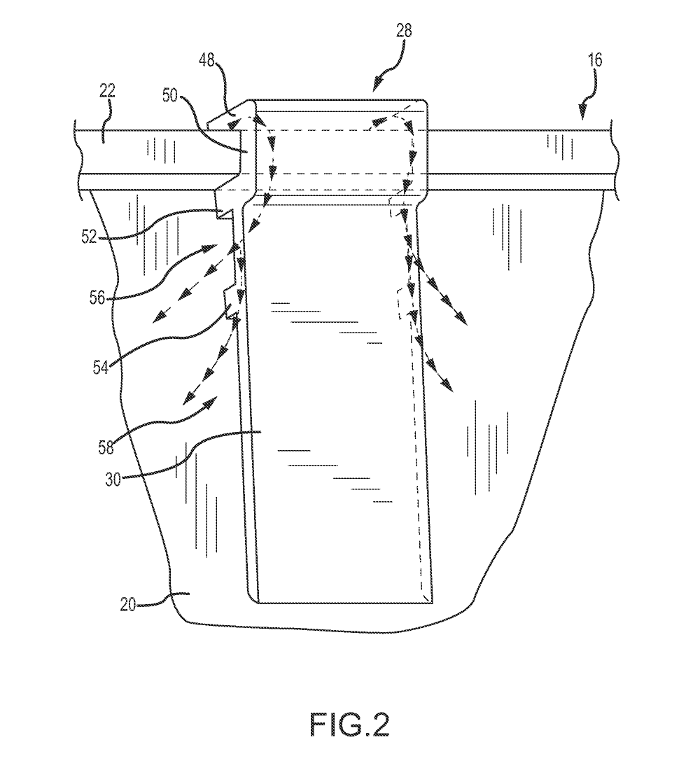

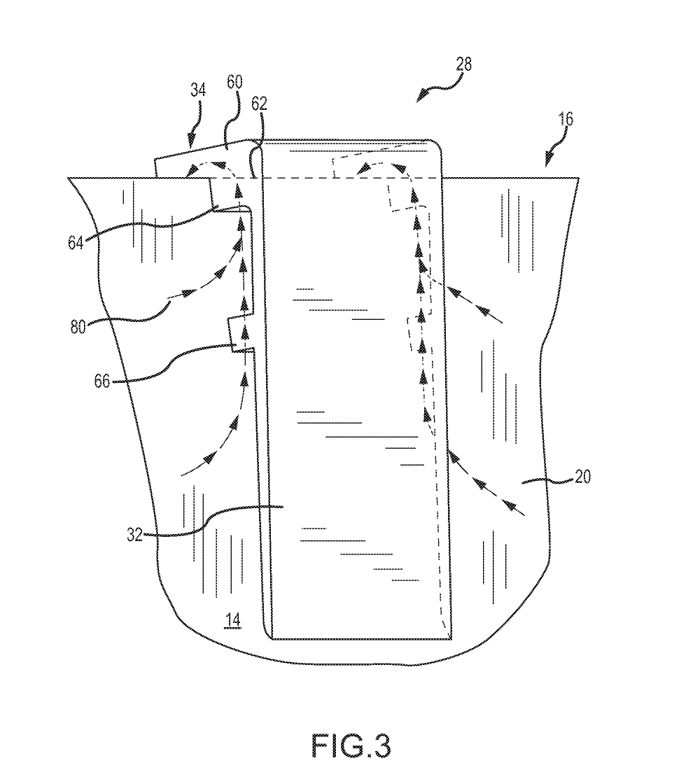

With reference to FIGS. 1-3, the present disclosure provides a waste receptacle ventilation system 10 and method to provide a continuous exchange of air between an airspace 12, between interior surface 14 of a waste receptacle 16 and an exterior of a trash bag 18 or liner, and the environment surrounding the waste receptacle 16. This continuous exchange of air limits the buildup of odors and reduces excess heat which may be generated by the decomposition of waste within the trash bag 18.

With reference to FIG. 1 a waste receptacle 16 include a waste receptacle wall 20 that extends around a periphery of the waste receptacle 16 and may be a cylinder, rectangle or other appropriate shape. A lower end portion of the waste receptacle wall 20 terminates at bottom wall (not shown). An upper end portion of the waste receptacle wall 20 terminates in a peripheral edge portion 22 which defines an opening to the waste receptacle 16. In at least some embodiments, the peripheral edge portion 22 is substantially solid and is shaped provide a mechanical coupling point for a waste receptacle lid 24, having an engagement lip 26 that removably engages the peripheral edge portion 22 in a manner that secures the waste receptacle lid 24 with the waste receptacle 16. The shape and operational nature of the peripheral edge portion 22 and the engagement lip 26 are depicted in exemplary embodiments, which should not be construed as limiting in nature. The waste receptacle 16 and its waste receptacle lid 24 may be provided in a nearly limitless number of different shapes and configurations without departing from the scope and nature of the present technology. As those of skill in the art will appreciate, the waste receptacle ventilation system 10 is sufficiently adaptable for use with a wide array of different waste receptacles 16, which may or may not include waste receptacle lids 24.

In various embodiments, the waste receptacle ventilation system 10 includes one or more ventilation clips 28. Embodiments of the ventilation clips are provided with an inverted U-shape, having an exterior arm 30 and an opposing interior arm 32. Proximal end portions of the exterior arm 30 and an opposing interior arm 32 operatively engage one another at a base portion 34. The exterior arm 30 and an opposing interior arm 32 terminate at opposite free distal end portions. The exterior arm 30 and an opposing interior arm 32 at least partially define a wall engagement space 36 between the exterior arm 30 and an opposing interior arm 32. In some embodiments, the exterior arm 30 and an opposing interior arm 32 extend outwardly form the base portion 34 so that the exterior arm 30 and an opposing interior arm 32 are biased toward one another at their distal end portions. In this manner, the distance between the exterior arm 30 and an opposing interior arm 32 will be greater adjacent the base portion 34 at the proximal end portions than at the distal end portions. In at least some embodiments, the biased nature of the exterior arm 30 and an opposing interior arm 32 may provide a snug, friction fit for the waste receptacle wall 20 within the wall engagement space 36.

It is contemplated that the wall engagement space 36 will be shaped to receive a portion of a waste receptacle wall 20 and, in particular, the peripheral edge portion 22. In some embodiments, the ventilation clips 28 may be extendable and retractable at their base portions 34 in order to accommodate different widths and shapes of waste receptacle walls 20 and peripheral edge portions 22. In some such embodiments, the ventilation clip 28 includes a male section 38 and a female section 40. With reference to FIG. 1, an exemplary embodiment depicts the female section 40 coupling with the male section 38 by a telescoping joint 42 by which the male section 38 may extend and retract with respect to the female section 40 to accommodate varying widths of the waste receptacle 16 and/or peripheral edge portion 22. It is contemplated, however, that embodiments of the ventilation clips will include a one-piece base portion 34 that does not include a telescoping joint 42.

In some embodiments, the male section 38 is positioned adjacent the proximal end portion of the exterior arm 30 and may be shaped to include a conforming lip section 44. The conforming lip section 44 bows outwardly to cooperate with and conform to a waste receptacle lip 46 that extends outwardly form the peripheral edge portion 22 of the waste receptacle wall 20. In at least one embodiment, the conforming lip section 46 is defined by a top portion 48 which terminates at a downwardly turned vertical portion 50. The vertical portion 50 terminates at a bottom portion 52, which may be opposed to the top portion 48. The top portion 48, vertical portion 50, and bottom portion 52 may have rectangular cross-sections, curvilinear cross-sections, or other appropriate cross-sectional configurations. At least some embodiments of the ventilation clips 28, however, provide an exterior arm 30 that is not shaped to include a conforming lip section 44. Such embodiments may be beneficial for use with a waste receptacle 16 having a low profile or flat peripheral edge portion 22. The exterior arm 30 continues to extend outwardly from the bottom portion 52 to its terminal end portion. A spacer 54 may extend from an interior surface of the exterior arm 30 such that a distal end of the spacer 54 engages an exterior surface of the waste receptacle wall 20 to space portions of the exterior arm 30 from the exterior surface of the waste receptacle wall 20. In this manner, a distal end of the bottom portion 52, the waste receptacle wall 20, the exterior arm 30, and the spacer 54 define a first outer cavity 56. Similarly, the spacer 54, the waste receptacle wall 20, and the exterior arm 30 define a second outer cavity 58. In various embodiments, the first outer cavity 56 and second outer cavity 58 do not have sidewalls that extend between the exterior arm 30 toward the exterior surface of the waste receptacle wall 20. In this manner, the first outer cavity 56 and second outer cavity 58, in such embodiments, are open to the environment surrounding the trash receptacle ventilation system 10 and the waste receptacle 16.

In various embodiments, the female section 40 is located at the proximal end portion of the interior arm 32 and may be shaped to have an inverted L-shaped cross-section. In some embodiments, the female section 40 includes a top portion 60 that terminates at a vertical portion 62 that extends downwardly from the top portion 60. In some embodiments, the top portion 60 and vertical portion 62 cooperate with one another to define a shoulder portion 64, having an L-shaped cross-section. The shoulder portion 64 is generally shaped to receive an interior edge portion of the peripheral edge portion 22. The top portion 60 and vertical portion 62 may have rectangular cross-sections, curvilinear cross-sections, or other appropriate cross-sectional configurations. The interior arm 32 continues to extend outwardly from the shoulder portion 64 to its terminal end portion. A spacer 66 may extend from an interior surface of the interior arm 32 such that a distal end of the spacer 66 engages the interior surface 14 of the waste receptacle wall 20 to space portions of the exterior arm 30 from the interior surface 14 of the waste receptacle wall 20. In this manner, the shoulder portion 64, the interior surface 14 of the waste receptacle wall 20, the interior arm 32, and the spacer 66 define a first interior cavity 68. Similarly, the spacer 66, the interior surface 14 of the waste receptacle wall 20, and the interior arm 32 define a second interior cavity 70. In various embodiments, the first interior cavity 68 and second interior cavity 70 do not have sidewalls that extend between the interior arm 32 toward the interior surface 14 of the waste receptacle wall 20. In this manner, the first interior cavity 68 and second interior cavity 70, in such embodiments, are open to the airspace 12, between interior surface 14 of a waste receptacle 16 and an exterior of a trash bag 18 or liner.

With reference to FIG. 1, embodiments of the ventilation clips 28 provide the female top portion 60 with a first inner fluid channel 72 that extends from an opening 74 in the shoulder portion 64, along a long axis through the female top portion 60. In such embodiments, the male top portion 48 includes a first outer fluid channel 76 that extends from an opening 78 in the bottom portion 52 of the conforming lip section 44, along a long axis through vertical portion 50, and the male top portion 48. The first inner fluid channel 72 and the first outer fluid channel 76 are positioned coaxially with one another and in open fluid communication with one another to provide a continuous fluid pathway through the female top portion 60 and the male top portion 48. The first inner fluid channel 72 and the first outer fluid channel 76 remain in fluid communication with one another as the male section 38 extends or retracts with respect to the female section 40 when the base portion 34 is telescopically adjusted to accommodate varying widths of the waste receptacle 16 and/or peripheral edge portion 22.

In various embodiments, the opening 74 of the first inner fluid channel 72 is in open fluid communication with the first interior cavity 68 between the interior arm 32 and the interior surface 14 of the waste receptacle wall 20. In some embodiments, the spacer 66 may include an open fluid pathway 80 that penetrates the spacer 66, transversely, to place the first interior cavity 68 and the second interior cavity 70 in open fluid communication with one another. Similarly, the opening 78 of the first outer fluid channel 76 is in open fluid communication with the first outer cavity 56 between the exterior arm 30 and the exterior surface of the waste receptacle wall 20. In some embodiments, the spacer 54 may include an open fluid pathway 82 that penetrates the spacer 54, transversely, to place the first outer cavity 56 and the second outer cavity 58 in open fluid communication with one another. In this manner, the first interior cavity 68 and second interior cavity 70 are placed in open fluid communication with the first outer cavity 56 and second outer cavity 58. As described above, embodiments of the present technology provide that the first outer cavity 56 and second outer cavity 58 do not have sidewalls that extend between the exterior arm 30 toward the exterior surface of the waste receptacle wall 20. Similarly, in such embodiments, the first interior cavity 68 and second interior cavity 70 may not have sidewalls that extend between the interior arm 32 toward the interior surface 14 of the waste receptacle wall 20. In this manner, the airspace 12, between interior surface 14 of a waste receptacle 16 and an exterior of a trash bag 18 or liner, is placed in open fluid communication with open to the environment surrounding the trash receptacle ventilation system 10 and the exterior of the waste receptacle 16.

In a method of ventilating a waste receptacle 16, one or more ventilation clips 28 are disposed over a peripheral edge portion 22 of a waste receptacle wall 20. In this position, interior arms 32 of the ventilation clips 28 are disposed along an interior surface 14 of the waste receptacle wall 20 and exterior arms 30 of the ventilation clips 28 are disposed along the exterior surface of the waste receptacle wall 20. A trash bag 18 or liner may be disposed within the interior of the waste receptacle 16. A peripheral edge portion 84 of the trash bag 18 or liner may be pulled over the peripheral edge portion 22 and a portion of the ventilation clips 28 and secured in place by conventional means. It will be desirable to have the peripheral edge portion 84 of the trash bag 18 or liner stop short of covering the open sides to at least a portion of the second outer cavity 58 and, in some embodiments, both the first outer cavity 56 and second outer cavity 58. Optionally, a waste receptacle lid may be coupled with the waste receptacle 16 by placing the engagement lip 26 over the peripheral edge portion 22 of the waste receptacle 16 and portions of the ventilation clips 28. In this manner, one or more (depending on the number of ventilation clips 28 used) open fluid pathways are positioned between the airspace 12, between interior surface 14 of a waste receptacle 16 and an exterior of a trash bag 18 or liner, and the environment surrounding the exterior of the waste receptacle 16. More specifically, fluid, in the form of air, vapor, and odor may flow along a fluid pathway from the airspace 12 through: the first interior cavity 68 and or second interior cavity 70; opening 74; first inner fluid channel 72; first outer fluid channel 76; opening 78; and first outer cavity 56 and/or second outer cavity 58, which exhaust to the environment surrounding the exterior of the waste receptacle 16. It is contemplated that ambient air from the environment surrounding the exterior of the waste receptacle 16 may follow the same fluid pathway but in reverse order.

Although the technology has been described in language that is specific to certain structures, materials, and methodological steps, it is to be understood that the invention defined in the appended claims is not necessarily limited to the specific structures, materials, and/or steps described. Rather, the specific aspects and steps are described as forms of implementing the claimed invention. Since many embodiments of the invention can be practiced without departing from the spirit and scope of the invention, the invention resides in the claims hereinafter appended. Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques. Moreover, all ranges disclosed herein are to be understood to encompass and provide support for claims that recite any and all subranges or any and all individual values subsumed therein. For example, a stated range of 1 to 10 should be considered to include and provide support for claims that recite any and all subranges or individual values that are between and/or inclusive of the minimum value of 1 and the maximum value of 10; that is, all subranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth).

What is claimed is:

1. A ventilation system for use with a waste receptacle having an interior and a trash bag disposed within the interior of the waste receptacle, defining an airspace between the trash bag and an inner surface of a waste receptacle wall, the ventilation system comprising:
at least one ventilation clip having a base portion, an exterior arm extending outwardly from an end portion of the base portion, and an interior arm extending outwardly from an opposite end portion of the base portion; the exterior arm and interior arm positioned in a spaced apart relationship with one another that defines a wall engagement space between base portion, the exterior arm, and interior arm;
the interior arm and base portion at least partially defining an interior cavity;
the exterior arm and base portion at least partially defining an outer cavity;
a fluid channel extending through the base portion of the at least one ventilation clip between an interior opening, which is in open fluid communication with the interior cavity, and an outer opening, which is in open fluid communication with the outer cavity.

2. The ventilation system of claim 1 wherein:
the base portion of the at least one ventilation clip is comprised of a female section and a male section that are coupled with one another at a telescopic joint by which the male section may extend and retract with respect to the female section and vary a width of the wall engagement space between the interior arm and the exterior arm; and
the fluid channel being divided between the female section and the male section.

3. The ventilation system of claim 1 wherein:
the base portion of the at least one ventilation clip includes a conforming lip section that is defined by a top portion, which terminates at a downwardly turned vertical portion, which in turn terminates at a bottom portion, which is opposed to the top portion;
the conforming lip section being shaped to receive a waste receptacle peripheral edge portion lip.

4. The ventilation system of claim 1 wherein:
the interior arm includes a spacer that extends outwardly from an interior surface of the interior arm and divides the interior cavity into a first interior cavity and a second interior cavity;
the spacer including an open fluid pathway that penetrates the spacer, transversely, placing the first interior cavity and the second interior cavity in open fluid communication with one another.

5. The ventilation system of claim 4 wherein:
the first interior cavity and the second interior cavity are in open fluid communication with the interior opening of the fluid channel that extends through the base portion of the at least one ventilation clip.

6. The ventilation system of claim 4 wherein:
the exterior arm includes a spacer that extends outwardly from an interior surface of the exterior arm and divides the outer cavity into a first outer cavity and a second outer cavity;
the spacer including an open fluid pathway that penetrates the spacer, transversely, placing the first outer cavity and the second outer cavity in open fluid communication with one another.

7. The ventilation system of claim 6 wherein:
the first outer cavity and the second outer cavity are in open fluid communication with the outer opening of the fluid channel that extends through the base portion of the at least one ventilation clip.

8. The ventilation system of claim 6 wherein:
the first interior cavity and the second interior cavity are in open fluid communication with the interior opening of the fluid channel that extends through the base portion of the at least one ventilation clip; and
the first outer cavity and the second outer cavity are in open fluid communication with the outer opening of the fluid channel that extends through the base portion of the at least one ventilation clip.

9. In combination:
a waste receptacle, having an interior, defined by at least one waste receptacle wall, and an open upper end, defined by a peripheral edge portion;
a trash bag disposed within the interior of the waste receptacle, defining an airspace between the trash bag and an inner surface of a waste receptacle wall; and
a ventilation system, comprising:
at least one ventilation clip having a base portion, an exterior arm extending outwardly from an end portion of the base portion, and an interior arm extending outwardly from an opposite end portion of the base portion; the exterior arm and interior arm positioned in a spaced apart relationship with one another that defines a wall engagement space between base portion, the exterior arm, and interior arm;
the interior arm and base portion at least partially defining an interior cavity;
the exterior arm and base portion at least partially defining an outer cavity;
a fluid channel extending through the base portion of the at least one ventilation clip between an interior opening, which is in open fluid communication with the interior cavity, and an outer opening, which is in open fluid communication with the outer cavity;
the at least one ventilation clip being coupled with the waste receptacle so that a portion of the peripheral edge portion and a portion of the waste receptacle wall are disposed within the wall engagement space between base portion, the exterior arm, and interior arm, such that: (i) the base portion is positioned closely adjacent the peripheral edge portion of the waste receptacle; (ii) the exterior arm extending along an exterior surface of the waste receptacle wall; and (iii) the interior arm extending along an interior surface of the waste receptacle wall;
the interior arm of the at least one ventilation clip being at least partially disposed within the airspace between the trash bag and an inner surface of a waste receptacle wall.

10. The combination of claim 9 wherein:
the base portion of the at least one ventilation clip is comprised of a female section and a male section that are coupled with one another at a telescopic joint by which the male section may extend and retract with respect to the female section and vary a width of the wall engagement space between the interior arm and the exterior arm to approximate a shape of the peripheral edge portion of the waste receptacle; and
the fluid channel being divided between the female section and the male section.

11. The combination of claim 9 wherein:
the base portion of the at least one ventilation clip includes a conforming lip section that is defined by a top portion, which terminates at a downwardly turned vertical portion, which in turn terminates at a bottom portion, which is opposed to the top portion;
the conforming lip section being shaped to receive a peripheral edge portion lip that extends outwardly from the waste receptacle.

12. The combination of claim 9 wherein:
the interior arm of the at least one ventilation clip includes a spacer that extends outwardly from an interior surface of the interior arm, divides the interior cavity into a first interior cavity and a second interior cavity, and engages an interior surface of the waste receptacle wall;
the spacer including an open fluid pathway that penetrates the spacer, transversely, placing the first interior cavity and the second interior cavity in open fluid communication with one another.

13. The combination of claim 12 wherein:
the first interior cavity and the second interior cavity are in open fluid communication with: (i) the interior opening of the fluid channel that extends through the base portion of the at least one ventilation clip; and (ii) the airspace between the trash bag and an inner surface of a waste receptacle wall.

14. The combination of claim 12 wherein:
the exterior arm includes a spacer that extends outwardly from an interior surface of the exterior arm, divides the outer cavity into a first outer cavity and a second outer cavity, and engages an exterior surface of the waste receptacle wall;
the spacer including an open fluid pathway that penetrates the spacer, transversely, placing the first outer cavity and the second outer cavity in open fluid communication with one another.

15. The combination system of claim 14 wherein:
the first outer cavity and the second outer cavity are in open fluid communication with: (i) the outer opening of the fluid channel that extends through the base portion of the at least one ventilation clip; and (ii) an environmental airspace exterior to the waste receptacle.

16. The combination of claim 14 wherein:
the first interior cavity and the second interior cavity are in open fluid communication with: (i) the interior opening of the fluid channel that extends through the base portion of the at least one ventilation clip; and (ii) the airspace between the trash bag and an inner surface of a waste receptacle wall; and
the first outer cavity and the second outer cavity are in open fluid communication with: (i) the outer opening of the fluid channel that extends through the base portion of the at least one ventilation clip; and (ii) an environmental airspace exterior to the waste receptacle.

17. The combination of claim 9 further comprising:
a waste receptacle lid having an engagement lip that is mechanically coupled with the peripheral edge portion of the waste receptacle in a manner that secures the waste receptacle lid with the waste receptacle;
at least portions of the at least one ventilation clip being disposed between the engagement lip of the waste receptacle lid and the peripheral edge portion of the waste receptacle.

18. A ventilation system for use with a waste receptacle having an interior and a trash bag disposed within the interior of the waste receptacle, defining an airspace between the trash bag and an inner surface of a waste receptacle wall, the ventilation system comprising:
at least one ventilation structure having a base portion, an exterior arm extending outwardly from an end portion of the base portion, and an interior arm extending outwardly from an opposite end portion of the base portion;
a fluid channel extending through the base portion, exterior arm, and interior arm of the at least one ventilation structure between an interior opening, which is in open fluid communication with the airspace between the trash bag and the inner surface of the waste receptacle wall, and an outer opening, which is in open fluid communication with an environmental airspace exterior to the waste receptacle.

19. The ventilation system of claim 18 wherein:
the ventilation structure has a generally U-shaped cross-section; the base portion of the ventilation structure positioned closely adjacent a peripheral edge portion of the waste receptacle such that the interior arm extends along an inner surface of a waste receptacle wall of the receptacle and the exterior arm is positioned exterior to the waste receptacle.

20. The ventilation system of claim 19 wherein:
the ventilation structure is shaped to be removably engageable with the peripheral edge portion of the waste receptacle, between the peripheral edge portion of the waste receptacle and an engagement lip of a waste receptacle lid, which is removably engageable with the peripheral edge portion of the waste receptacle.
